(19) United States
(12) Patent Application Publication
(10) Pub. No.: US 2012/0186166 A1
(43) Pub. Date: Jul. 26, 2012

(54) FOLDABLE STRUCTURE

(75) Inventor: Thomas Casto, Mead, WA (US)

(73) Assignee: Thomas Castro, Mead, WA (US)

(21) Appl. No.: 13/356,548

(22) Filed: Jan. 23, 2012

Related U.S. Application Data
(60) Provisional application No. 61/435,224, filed on Jan. 21, 2011.

(51) Int. Cl. E04B 1/343; B21D 47/00; E04H 1/00; B23P 11/00

(52) U.S. Cl. 52/79.5; 29/428; 29/897.3

(57) ABSTRACT

A foldable structure is adjustable between a folded condition for storage and shipping, and an unfolded condition for occupation by one or more users. The foldable structure may be substantially prefabricated at a manufacturing facility, transitioned into its folded condition, and placed into a shipping container for shipping to a destination site. A single foldable structure may be placed in the shipping container, or multiple foldable structures may fit in a standard shipping container. For example, in some embodiments, as many as six foldable structures may fit in a single standard shipping container.

### RELATED APPLICATION

This application claims priority to U.S. provisional Patent Application No. 61/435,224, filed on Jan. 21, 2011, the disclosure of which is incorporated by reference herein.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1A is a plan view of an example foldable structure in an unfolded condition providing an interior usable space for occupation by a user.

FIG. 1B is a plan view of the foldable structure of FIG. 1A in a partially folded condition.

FIG. 1C is a plan view of the foldable structure of FIG. 1A in a folded condition for shipping or storage.

FIG. 2A is a plan view of another example foldable structure in an unfolded condition providing an interior usable space for occupation by a user.

FIG. 2B is a plan view of the foldable structure of FIG. 2A in a folded condition for shipping or storage.

FIG. 3 is a cross-sectional view of another example foldable structure in an unfolded condition showing an example access panel for anchoring walls of the foldable structure to a concrete slab or other foundation.

FIG. 4 is a partial cross-sectional view showing a wall of the foldable structure of FIG. 3 in an exploded view, and showing details of an example slide mechanism to facilitate transitioning of the foldable structure between the folded and unfolded conditions.

FIG. 5 is a flow chart of an example method of installing a foldable structure.

### DETAILED DESCRIPTION

### Overview

This disclosure relates to a foldable structure that is adjustable between a folded condition for storage and shipping, and an unfolded condition for occupation by one or more users. The foldable structure may be substantially prefabricated at a manufacturing facility, transitioned into its folded condition, and placed into a shipping container for shipping to a destination site. In some embodiments, a single foldable structure may be placed in the shipping container, but in other embodiments multiple foldable structures may fit in a standard shipping container. For example, in some embodiments, as many as six foldable structures may fit in a single standard shipping container.

At the destination site, the foldable structure may be removed from the shipping container, transitioned into its unfolded condition, and anchored to a foundation. In some embodiments, walls of the foldable structure may be anchored directly to a concrete slab or other foundation, without the need for any floor structure. The omission of a floor structure allows the foldable structure to be folded into a more compact folded structure than other prefabricated structures.

### Example Foldable Structures

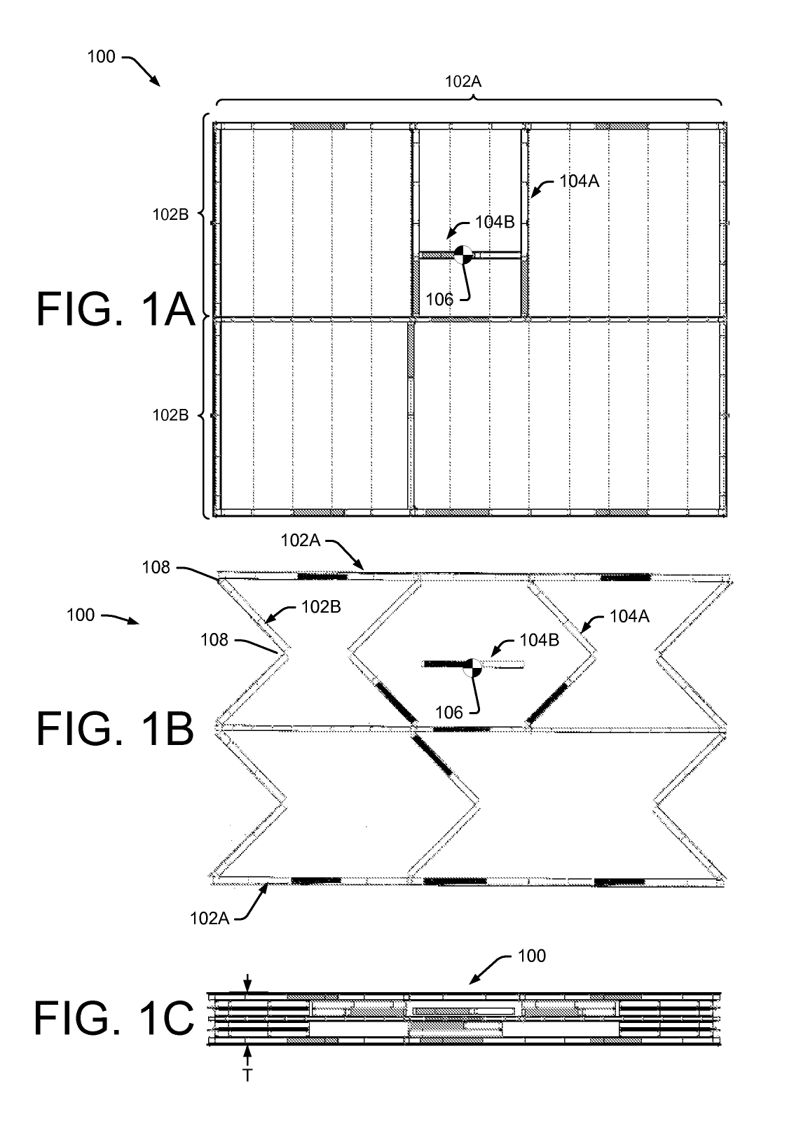

FIGS. 1A-1C illustrate an example foldable structure 100, which is adjustable between an unfolded condition (FIG. 1A) for use and a folded condition (FIG. 1C) for shipping or storage.

FIG. 1A is a plan view illustrating the foldable structure 100 in an unfolded condition providing an interior usable space for occupation by a user. The foldable structure includes a plurality of exterior walls including a plurality of non-folding exterior walls 102A and a plurality of folding exterior walls 102B (collectively referred to herein as exterior walls 102). The foldable structure also includes one or more interior walls, including non-folding interior walls 104A and folding interior walls 104B (collectively referred to herein as interior walls 104). The walls may be wired/plumbed at the time of manufacturing and/or may be configured with conduit or pass-throughs to facilitate wiring/plumbing onsite. In the illustrated example, one or more water source and/or discharge lines 106 may be located in one of the interior walls, to be connected to water and/or sewer lines at the destination site. In some examples, the plumbing and water supply and/or discharge lines 106 may all be located in a single interior wall to facilitate easy of hookup at the destination site, and to minimize (or eliminate entirely) the number of plumbing connections during installation of the foldable structure 100 at the destination site. However, in other embodiments, walls may be pre-plumbed with flexible tubing to avoid making pluming connections during installation.

FIG. 1B illustrates the foldable structure 100 in a partially folded condition. As shown in FIG. 1 B, each of the folding exterior walls 102B and folding interior walls 104B includes one or more hinges 108 facilitating folding of the folding walls. Also, each of the foldable exterior walls 102B and foldable interior walls 104B is connected to adjoining walls by one or more hinges 108. The hinges 108 may comprise standard door hinges, living hinges, or any other conventional hinges. The hinges 108 may be located on either side of a wall to facilitate folding in the desired direction. Alternatively, the hinges 108 may comprise compound hinges that facilitate folding in either direction. Additionally or alternatively, some or all of the hinges 108 may include locks to lock the hinges in the folded and/or unfolded conditions for additional stability in the unfolded condition and/or to minimize movement of the foldable structure for ease of handling during shipping.

FIG. 1C is a plan view of the foldable structure of FIG. 1A in a folded condition for shipping or storage. In the folded condition, the foldable structure 100 has a thickness T which is substantially less than that of the unfolded structure. For example, in some embodiments, in the folded condition the foldable structure 100 may have a smallest dimension which is at most ⅙^{th} that of the same dimension in the unfolded condition. In some embodiments, the smallest dimension in the folded condition may be at most 1 meter. In some embodiments, the foldable structure 100 may be sized to occupy at most ¼ of the volume of a standard shipping container, while in still other embodiments, the foldable structure is sized to occupy at most ⅙ of the volume of a standard shipping container.

In the unfolded condition, the folding exterior walls 102B are unfolded such that the non-folding exterior walls 102A are spaced apart from one another to define an interior space of the foldable structure. The exterior walls 102 are configured to be anchored in this condition to a foundation (not shown in this figure). In the folded condition, the folding exterior walls 102B are folded such that the non-chemical folding exterior walls 102A are collapsed together substantially eliminating the interior space of the foldable structure.

In the unfolded condition, the interior walls 104 define one or more rooms in the interior space of the foldable structure 100. In the folded condition, the folding interior walls 104B fold to allow the non-folding exterior walls 102A and the non-folding interior walls 104A to be collapsed together substantially eliminating the interior space of the foldable structure.

In the illustrated example, some walls are shows as being non-foldable walls, while other walls are shown as being foldable walls. However, in other examples, any or all of the interior and/or exterior walls may comprise folding walls. In still other embodiments, any or all of the walls may comprise non-foldable walls coupled together by hinges such that the walls are foldable relative to one another.

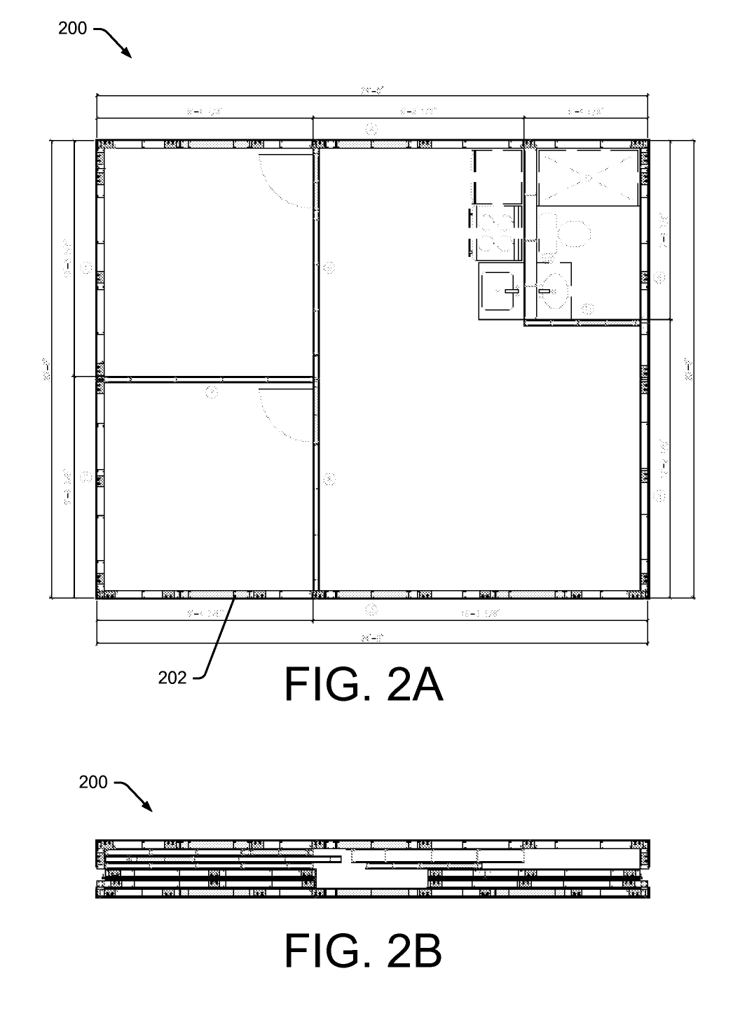

FIGS. 2A and 2B illustrate another example of a foldable structure 200 in an unfolded condition and a folded condition, respectively. The foldable structure 200 has a different floor plan and folds differently than the foldable structure 100 described above. Also, the walls in this embodiment are shown to include markings 202 designating locations for roof trusses, second story floor joists (if applicable), and/or rafters. In various examples, the roof may comprise a pitched roof (e.g., gabled, Hip, shed, etc.), a flat roof, or any other desired roof type, and the trusses or rafters used may be chosen according to the type of roof used. Moreover, FIG. 2A includes illustrative dimensions, and depicts several illustrative fixtures that may be installed in the foldable structure, such as a toilet, kitchen skin, bathroom sink, stove, and the like. However, the illustrated dimensions and fixtures are merely illustrative and foldable structures according to this disclosure may be constructed in a variety of other smaller and larger sizes, and may include any combination of these and other fixtures. In all other respects, the foldable structure 200 of FIGS. 2A and 2B may be constructed using any of the techniques and structures described above with respect to FIGS. 1A-1C. Thus, for the sake of brevity, FIGS. 2A and 2B will not be described further herein.

Thus, in some embodiments, two, four, or even six foldable structures may fit in a single standard shipping container. For example, six approximately 500 square foot foldable structures, having two bedrooms and a kitchen, such as that shown in FIGS. 2A and 2B, can fit in a single standard shipping container. In such an example, the foldable structures may have unfolded dimensions of about 20 feet wide, about 24.5 feet long, an up to 8.8 feet tall, and a wall thickness of about 4.5 inches. Thus, in a folded condition, each foldable structure would have dimensions of at most about 2.7 feet wide, at most about 26 feet long, and at most about 8.8 feet tall. As such, six of the folded structures may be placed two-deep and three-wide into a standard 53 foot High Cube shipping container (having interior dimensions of about 52.5 feet long, about 8.2 feet wide, and about 9.1 feet tall). Of course, if different room configurations, different wall thicknesses, different room sizes and/or different shipping containers are used, different numbers of structures (1, 2, 3, 4, 5, 6, 7, 8, or even more than 8) can be made to fit within a single standard shipping container.

### Example Installation

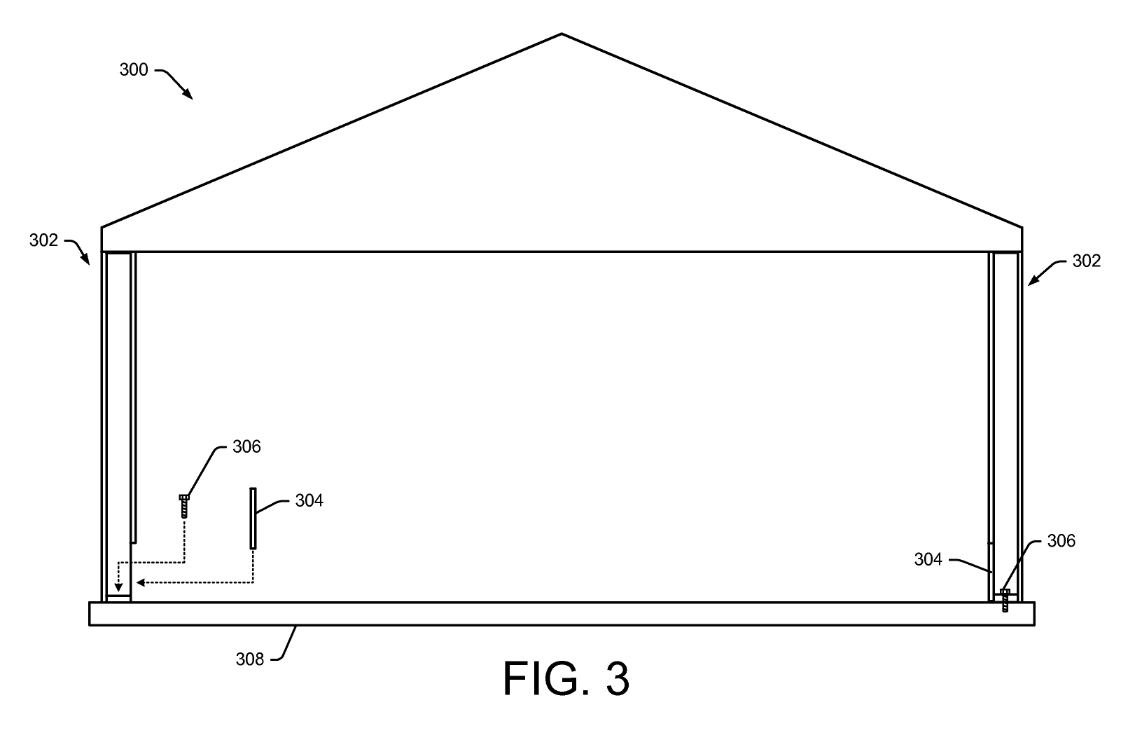

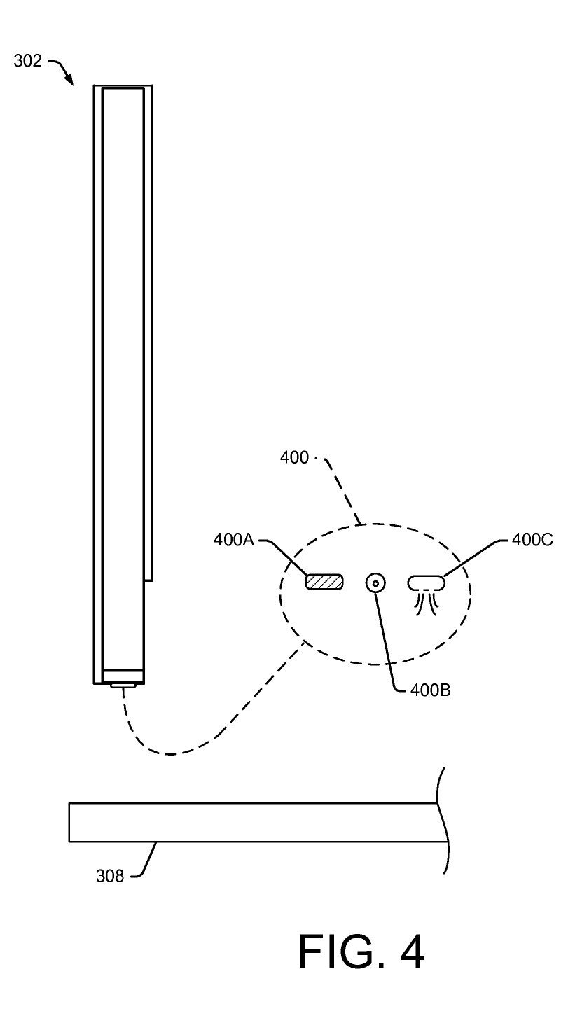

FIGS. 3 and 4 illustrate aspects of the installation or setup of a foldable structure, such as the foldable structures 100 and 200. FIG. 3 is a cross-sectional view of another example foldable structure 300 in an unfolded condition. In this example, the foldable structure 300 includes a plurality of walls 302. Interior walls have been omitted in this figure for clarity. The walls 302 may comprise wallboard, such as magnesium oxide board (“mag board”), gypsum board, exterior siding, wood paneling, combinations of any of the foregoing, or the like, coupled to a metal or wood frame. Regardless of their method of construction, the walls 302 may include an access panel 304, by which an installer can install an anchor 306, such as, for example, a lag bolt, concrete nail, or other concrete anchor to secure the foldable structure 300 to a concrete slab or other foundation 308. In one example, anchor 306 may comprise a Strong-Bolt™ wedge anchor, available from Simpson Strong-Tie of Pleasanton, Calif. The left wall 302 shown in FIG. 3 is shown with the access panel 304 removed for installation of the anchor 306. The right wall 302 shown in FIG. 3 is shown with the anchor 306 installed and the access panel 304 in place.

The walls 302 may have varying thicknesses, depending on local building codes, insulation requirements, structural requirements, and the like. In some embodiments, the total wall thickness may be between about 2.5 inches and about 6.5 inches. Smaller wall thicknesses will facilitate packaging larger numbers of foldable structures in a single shipping container. In contrast, greater wall thicknesses may be used for multi-story structures and/or where greater insulation is desired.

As shown in FIG. 3, the walls of the foldable structure 300 may sit directly on the concrete slab or other foundation 308 (with or without a gasket or other seal along the bottom edge of the wall), without the need for any other floor structure. Rather, floor coverings may be applied directly on top of the concrete slab.

FIG. 4 is a partial cross-sectional view showing a wall of the foldable structure of FIG. 3 in an exploded view, and showing details of an example slides 400 to facilitate transitioning of the foldable structure between the folded and unfolded conditions. In various embodiments, the slide mechanism 400 may include a low friction skids 400A (e.g., made of Teflon), rollers 400B, or air bearings 400C. Air bearings 400C are configured to introduce a stream of air between the bottom surface of the wall and the concrete slab or other foundation (analogous to the operation of an air hockey table) to allow the walls to be moved more easily during installation. Air bearings 400C may be constructed in a variety of ways. In one example, an air bearing 400C may comprise a flexible tube with a plurality of air holes protruding from a bottom surface thereof. In such an embodiment, after the air bearing 400C has been used to move the walls into the unfolded condition, the air bearing 400C may be left in place and may form a gasket or seal between the bottom surface of the walls and the concrete slab or other foundation once the foldable structure is anchored.

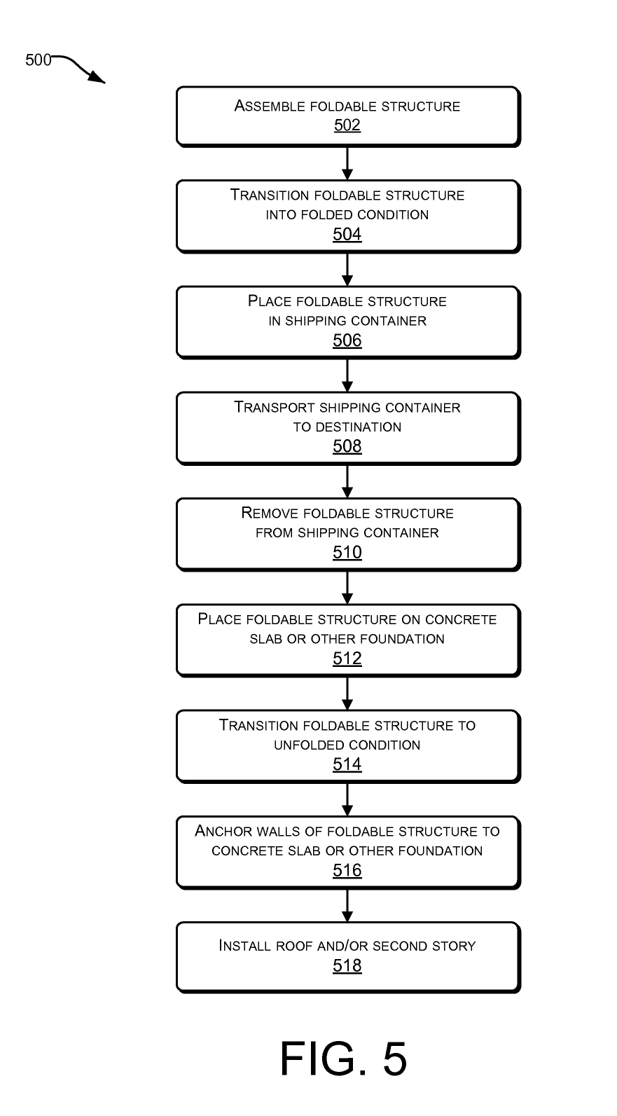

FIG. 5 is a flow chart of an example method 500 of installing a foldable structure, such as those shown in FIGS. 1-4. The operations shown in method 500 are self explanatory and for the sake of brevity will not be described in detail herein.

### Conclusion

Although the embodiments have been described in language specific to structural features and/or methodological acts, is the claims are not necessarily limited to the specific features or acts described. Rather, the specific features and acts are disclosed as illustrative forms of implementing the subject matter described in the disclosure.

What is claimed is:

1. A foldable structure comprising:
a plurality of exterior walls including a plurality of non-folding exterior walls and a plurality of folding exterior walls;
a plurality of hinges facilitating folding of the folding exterior walls, and pivotably coupling the exterior walls together to define a continuous perimeter of the foldable structure, the foldable structure being adjustable between:
an unfolded condition, in which the folding exterior walls are unfolded such that the non-folding exterior walls are spaced apart from one another to define an interior space of the foldable structure, the exterior walls being configured to be anchored to a foundation; and
a folded condition, in which the folding exterior walls are folded such that the non-folding exterior walls are collapsed together substantially eliminating the interior space of the foldable structure.

2. The foldable structure of claim 1, further comprising at least one foldable interior wall, which in the unfolded condition of the foldable structure at least partially defines a room of the interior space of the foldable structure, and which in the folded condition of the foldable structure folds to allow the non-folding exterior walls to be collapsed together substantially eliminating the interior space of the foldable structure.

3. The foldable structure of claim 2, further comprising at least one non-foldable interior wall, which in the unfolded condition of the foldable structure at least partially defines a room of the interior space of the foldable structure, and which in the folded condition of the foldable structure are collapsed together substantially eliminating the interior space of the foldable structure.

4. The foldable structure of claim 1, wherein the exterior walls comprise wallboard coupled to a metal frame.

5. The foldable structure of claim 4, wherein the wallboard comprises magnesium oxide wallboard.

6. The foldable structure of claim 4, wherein the wallboard comprises gypsum board, exterior siding, and/or wood paneling.

7. The foldable structure of claim 1, further comprising plumbing for one or more water sources and/or discharges, the plumbing being disposed in only one interior wall of the foldable structure.

8. The foldable structure of claim 1, the exterior walls further comprising anchors for securing the walls directly to a concrete slab, such that when installed the foldable structure sits directly on the concrete slab.

9. The foldable structure of claim 1, the exterior walls further comprising markings designating locations for roof trusses, second story floor trusses, and/or rafters.

10. The foldable structure of claim 1, the exterior walls further comprising slides to facilitate moving the exterior walls between the folded and unfolded conditions.

11. The foldable structure of claim 10, the slides comprising low friction skids, rollers, or air bearings.

12. The foldable structure of claim 1, wherein in the folded condition the foldable structure has a smallest dimension of at most 1 meter.

13. The foldable structure of claim 1, wherein in the folded condition the foldable structure is sized to occupy at most ¼ of the volume of a standard shipping container.

14. The foldable structure of claim 1, wherein in the folded condition the foldable structure is sized to occupy at most ⅙ of the volume of a standard shipping container.

15. The foldable structure of claim 1, wherein at least some of the hinges include locks to lock the hinges in the folded and/or unfolded conditions.

16. The foldable structure of claim 1, wherein each of the exterior walls has a thickness of between about 2.5 inches and about 6.5 inches.

17. The foldable structure of claim 1, wherein in the folded condition the foldable structure has a smallest dimension which is at most ⅙^{th} that of the same dimension in the unfolded condition.

18. The foldable structure of claim 1, one or more of the exterior walls includes an access panel on an interior and/or exterior surface of the exterior walls to provide access to anchor the respective exterior wall to the foundation of the foldable structure.

19. A foldable structure comprising a plurality of walls and being adjustable between a folded condition and an unfolded condition, wherein in the folded condition the foldable structure has a smallest dimension which is ⅙^{th} that of the same dimension in the unfolded condition.

20. The foldable structure of claim 19, wherein in the folded condition the foldable structure has a smallest dimension of at most 1 meter.

21. The foldable structure of claim 19, wherein in the folded condition the foldable structure is sized to occupy between about ⅙ and ¼ of the volume of a standard shipping container.

22. A method of installing a foldable structure, the method comprising:
removing the foldable structure from a shipping container;
transitioning the foldable structure from a folded condition to an unfolded condition; and
anchoring walls of the foldable structure directly to a foundation of the foldable structure.

23. The method of claim 22, further comprising installing a roof on the foldable structure.
